(19) United States
(12) Patent Application Publication
(10) Pub. No.: US 2006/0104063 A1
(43) Pub. Date: May 18, 2006

(54) Spotlight

(76) Inventors: John Anthony Dunne, Dingley (AU); Reuven Avital, Templestowe (AU); Hardian Nicholas Fraval, South Warrandyte (AU)

Correspondence Address: WELSH & KATZ, LTD, 120 S RIVERSIDE PLAZA, 22ND FLOOR, CHICAGO, IL, 60606, US

(21) Appl. No.: 10/527,273

(22) PCT Filed: Sep. 8, 2003
(86) PCT No.: PCT/AU03/01172

§ 371 Date: Aug. 2, 2005

(30) Foreign Application Priority Data
Sep. 9, 2002 (AU) 2003951304

(51) Int. Cl. F21V 9/00

(52) U.S. Cl. 362/277; 362/293

(57) ABSTRACT

A spotlight for generating an output light beam (9) of variable width, including a light source (1) having a selected focal length, and an aperture (3) for directing light from said light source to a first lens (5), said first lens (5) being movable to adjust the width of said output light beam (9), wherein the first lens (5) is moveable to a position closely adjacent to said aperture (3) and substantially about or at said selected focal length (FL) to minimize said output light beam width.

### FIELD OF THE INVENTION

The present invention relates to a spotlight, especially a spotlight for generating an output light beam of variable width. The invention is of particular application to the fields of search and rescue operations, the entertainment industry, security and law enforcement.

### BACKGROUND OF THE INVENTION

Spotlights are presently used in a wide variety of applications for the purpose of illuminating objects at night, especially distant objects. For example, spotlights are used in search and rescue operations to find missing persons. Spotlights are also used in the entertainment industry to illuminate performers on stage or entertainment venues. In these and other applications, spotlights are usually required to produce sufficient and consistent illumination at varying distances. This requires the output light beam to be adjustable in width while maintaining the intensity of the output light beam to be constant across the beam width.

Present prior art spotlights usually employ a parabolic-mirror in conjunction with a light source to generate a light beam which is then collimated to produce an output light beam of approximately 200-500 millimeters in diameter. The intensity of the output light beam from such spotlights is generally around 4 kW/m². Such intensities are often insufficient to meet the requirements for the application in hand, especially during night operations. In addition, the output light beam tends to focus at one part of the light beam width, thus producing a beam of uneven intensity. This type of beam has variations in brightness resulting in a variable intensity, structured beam, profile.

Filters are often used in conjunction with spotlights to produce a particular desired lighting effect. For example, a filter may be used to produce light of a particular colour or to produce a light beam with a range of wavelengths. Filters are ordinarily placed in the expanded output light beam path of the spotlight. That is, past the focal point of the light source. This is because standard filters cannot withstand the heat generated from the light source at closer distances. Another disadvantage with the prior art is that the filters are non-adjustable; that is, filters are usually installed mechanically through a slot or located at the front of the lens in the spotlight, meaning that a filter must be physically replaced with another filter by opening the spotlight assembly.

Thus, there is a need for producing spotlights which are able to adjust the width of the beam while maintaining a required intensity. There is also a need for a simple filter arrangement employed with spotlights which is more convenient and easily allows the substitution of filters when required.

### SUMMARY OF THE INVENTION

Accordingly, one aspect of the present invention provides a spotlight for generating an output light beam of variable width, including a light source having a selected focal length, and an aperture for directing light from said light source to a first lens, said first lens being movable to adjust the width of said output light beam, wherein the first lens is moveable to a position closely adjacent to said aperture and substantially about or at said selected focal length to minimise said output light beam width.

Positioning the moveable first lens closely adjacent to the aperture substantially about or at the selected focal length means that most, if not all, of the light from the light source is collected by the first lens and the moveability of the first lens adjusts the output beam width while retaining the same intensity output. Thus, the spotlight is able to produce output light beams of variable width while maintaining a sufficiently high intensity required for spotlight applications.

Preferably, the selected light focal length is such that the spotlight has an f number of between 1 and 1.6. Most preferably, the f number is at least 1.3.

It is preferred that the positioning of the first lens substantially at or about the selected focal length maximises the intensity of the output light beam. The intensity of the output light beam, at the focal point of the spotlight, preferably ranges between 2 megawatt/m² to 16 megawatts/m².

According to another aspect of the invention, the spotlight, in addition to the features of the first aspect, includes a selectively variable filter housing having two or more filters, said filter housing being rotatable to selectively interpose one of the said filters between said light source and said aperture to filter light from said light source.

The inclusion of a selectively variable filter housing allows for more than one filter to be fitted to the housing and enables a filter to be substituted by another filter easily and conveniently.

The filter housing preferably includes a portion to selectively interpose one of said filters, rotatable relative to the filter housing. In a preferred embodiment, the rotatable portion is a filter wheel.

It is preferred that the filter housing has at least one chamber for receiving one of the filters. Preferably, the at least one chamber is formed in the rotatable portion. The chambers are preferably radially offset in the filter housing from the rotational axis of the filter housing for selective interposition between the light source and the aperture.

At least one of the filters preferably includes multiple filter elements. The multiple filter elements can be formed in a stack in at least one chamber. The stack may include four to ten filter elements. The filter elements can be coated on one or both sides. The filters preferably filter light of different wavelengths.

In one embodiment, the filter wheel has at least one chamber. Preferably, the chambers are radially offset in the rotatable portion from the rotational axis of the rotatable portion.

The rotational axis of the filter housing or the rotatable portion is preferably parallel to and laterally disposed from the longitudinal axis of the spotlight.

The filter housing may be formed integrally with the aperture. It is preferred that the aperture is located in a recess portion of the filter housing and a portion of the first lens, when positioned closely adjacent to the aperture, nests in the recess portion. The recess portion may be correspondingly shaped to the shape of the portion of said first lens. The aperture may be radially located in the filter housing to be aligned with at least one chamber. In a preferred embodiment, the aperture is located on the opposite side of the filter housing to said at least one chamber. In a further preferred embodiment, the filter housing has a plurality of chambers and a plurality of apertures.

Preferably, a second lens is provided which is moveable relative to the first lens so as to collimate the output light beam at different distances. The first lens and second lens are preferably located on a lens mounting for simultaneous movement. The first lens and second lens may move at different linear rates, thus maintaining a crisp-edged, even beam profile at various distances from the spotlight output.

### BRIEF DESCRIPTION OF THE DRAWINGS

Preferred embodiments of the invention will now be described, by way of example only, with reference to the drawings of which:

FIG. 1 is a cross-sectional view of a spotlight according to a preferred embodiment of the invention;

FIG. 2A is a schematic diagram illustrating the principles of operation of the preferred embodiment of the invention;

FIG. 2B is a schematic diagram illustrating an alternative embodiment;

FIG. 3 is a perspective view of the filter housing used with the spotlight according to FIG. 1;

FIG. 4 is a perspective view of the filter housing of FIG. 1;

FIG. 5 is an exploded view of the filter housing of FIG. 1 with multiple filter elements;

FIG. 6 is a cross-sectional view of the filter housing of FIG. 1;

FIG. 7 is a cross-sectional view of a filter housing of another embodiment;

FIG. 8A is an exploded view of a lens mounting and a filter housing according to a preferred embodiment;

FIG. 8B is a perspective view of the assembled lens mounting and filter housing;

FIG. 9A is an exploded view of the lens mounting and filter housing of FIGS. 8A and 8B with a light source; and

FIG. 9B is a perspective view of the assembled lens mounting, filter housing and light source of FIG. 9A.

### DETAILED DESCRIPTION OF THE PREFERRED EMBODIMENTS

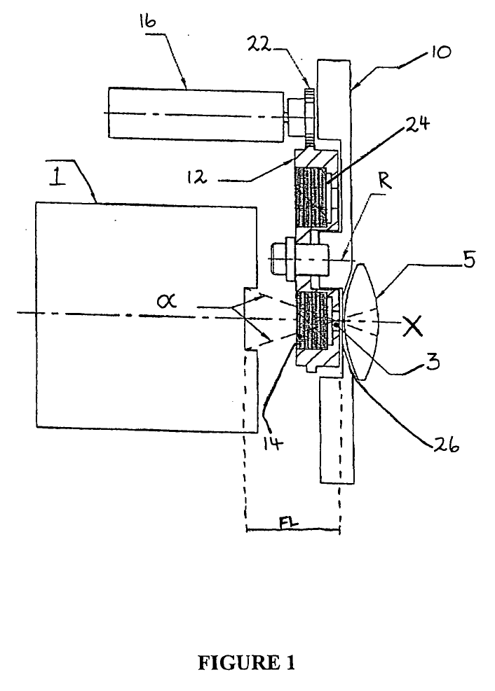

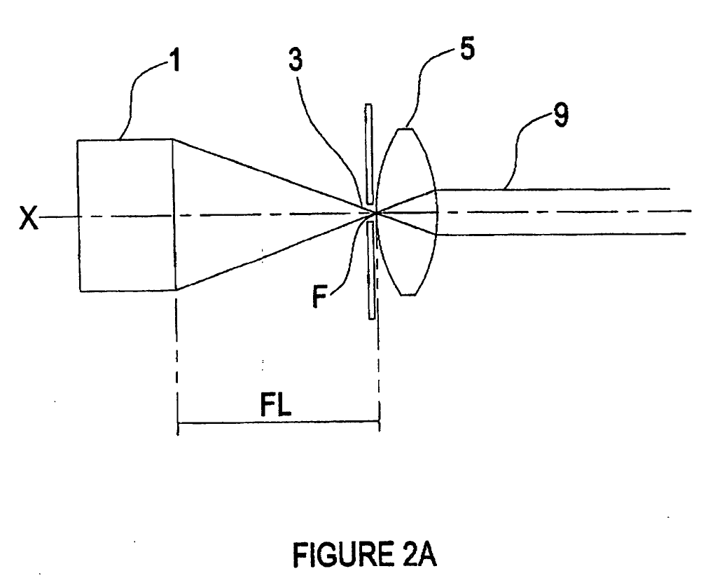

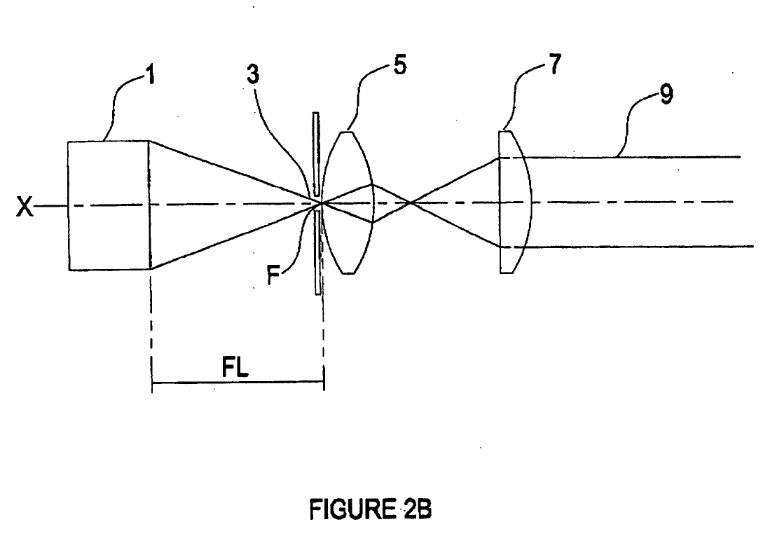

A spotlight according to a preferred embodiment of the invention is shown in FIG. 1. The spotlight has a light source 1, an aperture 3 and convex lens 5. The light source 1 has a selected focal length FL and a focal point F, as shown more clearly in FIG. 2A. The light source also generates a light beam angle α.

The lens 5 is moveable along the longitudinal axis X of the spotlight. Lens 5 is moveable along axis X so as to vary the width of the output light beam 9. In the position illustrated in FIG. 1, the lens 5 is located closely adjacent to aperture 3 substantially at the focal length FL and the focal point F of light source 1.

As can be seen in FIG. 2A, the spotlight operates by light from light source 1 passing through aperture 3 to the lens 5. By placing the lens 5 at the selected focal length FL of light source 1, the width of the output light beam 9 is minimised. In addition, the light generated by the light source 1 is substantially collected by lens 5 and therefore maximises the intensity of the output light beam 9.

It has been found that by choosing the appropriate light source having a focal length FL of between 25-40 mm, the f number of the spotlight ranges between 1 and 1.6 with intensities of 2 MWatt/m² to 16 MWatt/m². In a particularly preferred embodiment, using an elliptical lamp with a selected focal length FL=32.5 mm, the resultant spotlight has an f number of 1.3 with an output light beam having an intensity of 2.6 MWatts/m². For a 1500 Watt xenon lamp, intensities of up to 16 Mwatt/m² can be obtained. Generally, the longer the focal length FL, the higher the intensity of the light beam, measured at a distance of 20 metres from the output.

In the embodiment shown in FIG. 2A, lens 5 is convex so as to collimate the output light beam 9. In another embodiment shown in FIG. 2B, a second (plano-convex) lens 7 is positioned after convex lens 5 to collimate the output light beam 9. The lens and second lens 7 can be convex, plano-convex, or any other shape to collimate output light bean 9.

The preferred embodiment as described is unique to the field of spotlights as it is quite difficult in the prior art to achieve the desirable relatively small beam width at large distances while maintaining the intensity of the output light beam.

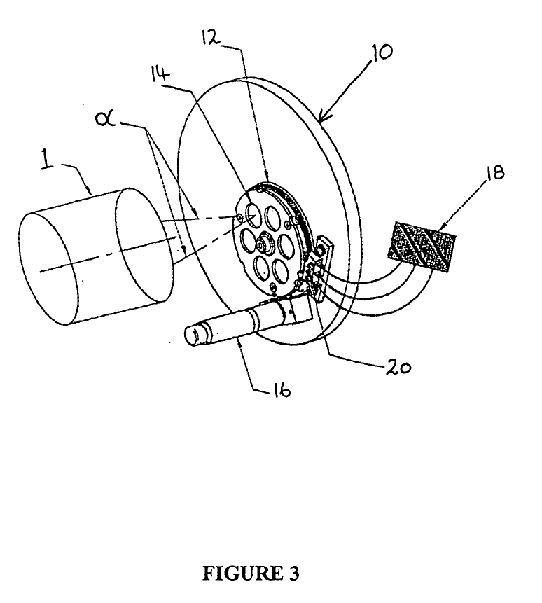

FIG. 1 also shows a further aspect in that the spotlight has a selectively variable filter housing 10. The filter housing 10 has a filter wheel 12, which contains two or more filters 14. Referring to FIGS. 1 and 3, the filter wheel 12 is driven by stepping motor 16, operable by a control unit 18 in conjunction with a positioning microswitch 20.

Referring to FIG. 1, the filter wheel 12 is rotatable about axis R relative to filter housing 10. The rotational axis R is parallel to and laterally displaced from longitudinal axis X of the spotlight. The motor 16 employs a drive gear 22 to selectively rotate filter wheel 12 so as to change the filter 14 interposed between the light source 1 and the aperture 3.

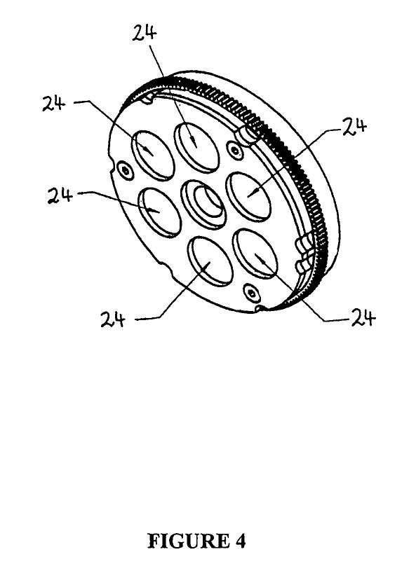

The filters 14 are held on filter wheel 12 via chambers 24 which are formed within the filter wheel 12. As shown in more detail in FIG. 4, the chambers 24 in filter wheel 12 are radially offset from rotational axis R to facilitate selective interposition of one of the filters 14 between the light source 1 and the aperture 3.

Selection and positioning of the filter 14 within the light path is determined by microswitch 20. Microswitch 20 is located in a recess in the circumference of filter wheel 12. Each chamber 24 is associated with at least one and preferably two recess locating points on the filter wheel 12 for selection and positioning by microswitch 20.

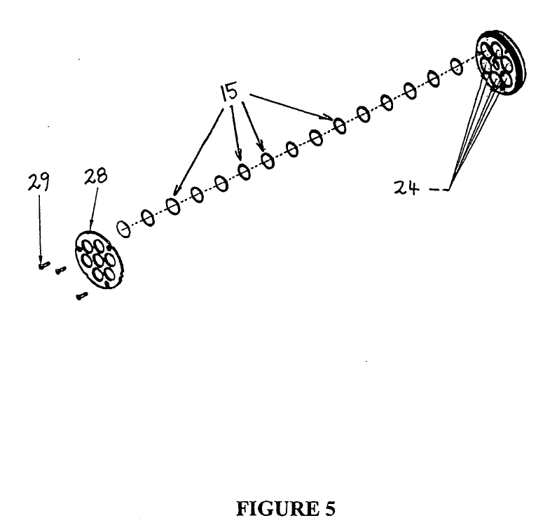

Each filter 14 may be composed of one or more individual filter elements 15. As shown in FIGS. 1 and 5, the filters 14 include a stack of separate filter elements 15 in each chamber 24. The number of filter elements 15 may vary between each filter 14 from four filter elements up to ten filter elements 15 (see FIG. 5) at a time. Moreover, the filter elements 15 can be coated on one or both of their sides. FIG. 5 also shows the filter wheel 12 in more detail, the filter wheel 12 having an end plate 28 which holds the filter elements 15 within chambers 24 via screws 29.

The filter housing 10 operates as follows. When a desired light effect is required for a particular spotlight application, control unit 18 activates the stepping motor 16 so as to rotate filter wheel 12 about axis R, selectively interposing one filter 14 between the light source 1 and aperture 3 to achieve the desired lighting effect. When a different light effect is required control unit 18 is activated, and as described before, filter wheel 12 rotates about axis R, selectively rotating chamber 24 until the required filter 14 is interposed between light source 1 and aperture 3.

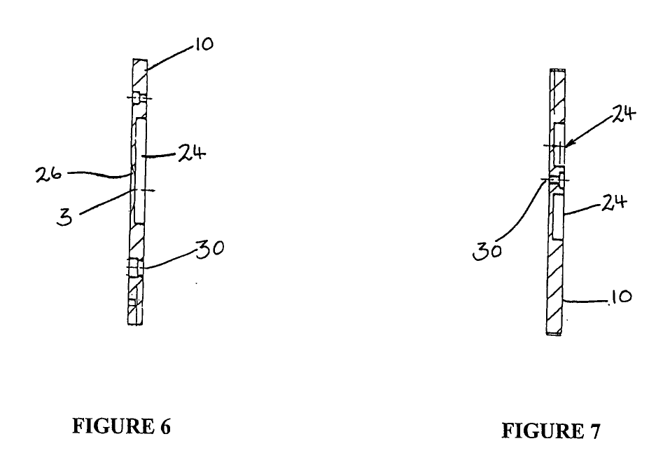

In the embodiment shown in FIGS. 1 and 6, the aperture 3 is formed integrally with filter housing 10. Generally, more than one aperture 3 may be provided so that there is an aperture 3 associated with each chamber 24. The aperture 3 is located in the filter housing 10 so as to correspond with the chamber 24 containing filter 14. A recessed portion 26 is provided in the filter housing 10 around aperture 3 so that the lens 5, when positioned closely adjacent to aperture 3, nests in the recess portion 26. The recessed portion 26 is also shaped to correspond with the shape of the lens 5. The aperture 3 is located on the opposite side of filter housing 10 to filter 14 (and chamber 24) interposed between light source 1 and aperture 3.

FIG. 7 shows another embodiment of the filter housing 10, where there is no integrally formed aperture. Rather, a separate housing or frame can be provided in the spotlight for the aperture. Providing a separate housing for the aperture allows the aperture to be adjustable so as to vary the output light beam width. In the case of the embodiment of FIG. 1, an adjustable aperture may be provided by providing apertures of differing diameters associated with different chambers 24 in the filter housing 10.

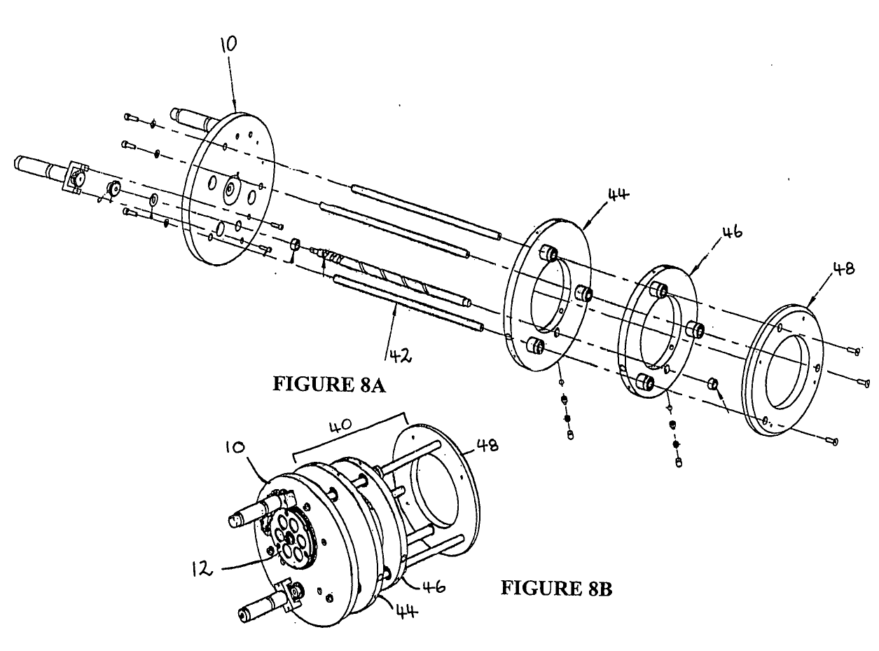

FIGS. 8A and 8B show a further preferred embodiment of the invention employing a second lens 7 as discussed in relation to FIG. 2B. In this embodiment, filter housing 10 is connected to a lens mounting 40 via rods 42. The lens mounting 40 has lens holders 44, 46 for the lens 5 and second lens 7, respectively. An end frame 48 is provided for supporting the lens mounting 40. Both lens holders 44, 46 are moveable along rods 42, allowing the lens 5 and second lens 7 to move simultaneously. The rods 42 may be provided with helical tracks of different pitches to cause the lens holders 44, 46 to move at different rates. This allows for adjustment of the focus of the spotlight at different distances.

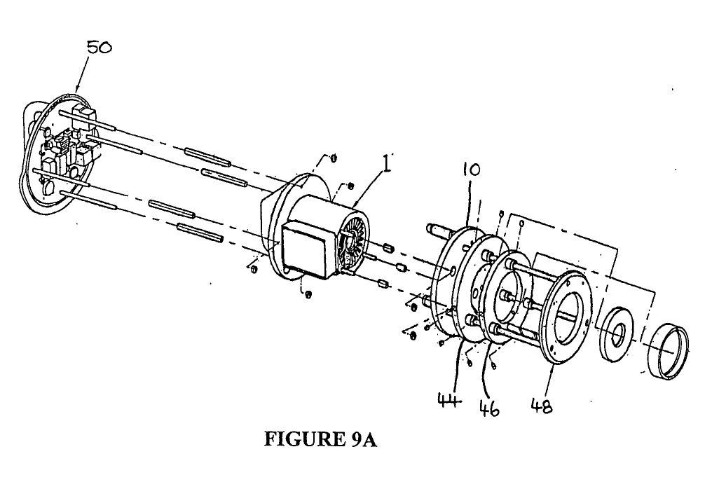

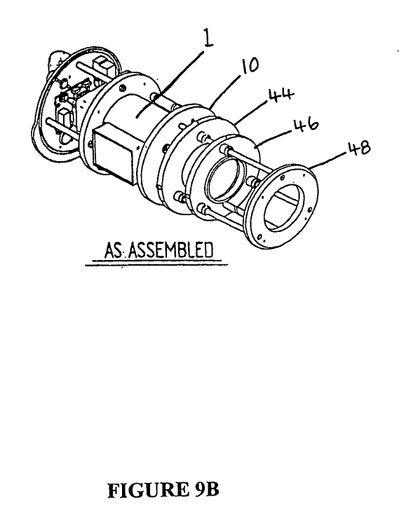

FIGS. 9A and 9B illustrate an assembled version of the preferred embodiment wherein light source 1, filter housing 10 (with filter wheel 12), lens mounting 40 (holders 44, 46 and end frame 48) are connected with an end plate 50 to form a single assembly which can be installed in a spotlight housing.

It is envisaged that the invention is applicable to spotlights in a variety of uses where powerful illumination is required for an output light beam of variable width. As discussed above, the invention can be applied to spotlights for search and rescue operations, security lighting, and lighting in entertainment industry.

In addition, the invention may be used in conjunction with the filter housing for the entertainment industry in providing the ability to use different coloured lights from the same spotlight as well as for security or military applications in providing green light, full covert or infrared (IR) covert light for the same spotlight.

The foregoing describes only one embodiment of the invention and modifications can be made without departing from the scope of the invention.

1. A spotlight from generating an output light beam of variable width, including a light source having a selected focal length, and an aperture for directing light from said light source to a first lens, said first lens being movable to adjust the width of said output light beam, wherein the first lens is moveable to a position closely adjacent to said aperture and substantially about or at said selected focal length to minimise said output light beam width.

2. The spotlight of claim 1, wherein the selected light focal length is such that the spotlight has an f number of between 1 and 1.6.

3. The spotlight of claim 2, wherein the f number is at least 1.3.

4. The spotlight of claim 1, wherein the positioning of the first lens substantially at or about the selected focal length maximises the intensity of the output light beam.

5. The spotlight of claim 4, wherein the intensity of the output light beam, at the focal point of the spotlight ranges between 2 megawatt/m² to 16 megawatts/m².

6. The spotlight of claim 1, further including a selectively variable filter housing having two or more filters, said filter housing being rotatable to selective interpose one of the said filters between said light source and said aperture to filter light from said light source.

7. The spotlight of claim 6, wherein the filter housing includes a portion, rotatable relative to the filter housing, to selectively interpose one of said filters.

8. The spotlight of claim 7, wherein the rotatable portion is a filter wheel.

9. The spotlight of claim 8, wherein the filter housing has at least one chamber for receiving one of the filters.

10. The spotlight of claim 9, wherein the at least one chamber is formed in the rotatable portion.

11. The spotlight of claim 10, wherein the chambers are radially offset in the filter housing from the rotational axis of the filter housing for selective interposition between the light source and the aperture.

12. The spotlight of claim 6, wherein at least one of the filters includes multiple filter elements.

13. The spotlight of claim 12, wherein the multiple filter elements are formed in a stack in one or more chambers.

14. The spotlight of claim 13, wherein the stack includes at least four filter elements.

15. The spotlight of claim 12, wherein the filter elements are coated on at least one side.

16. The spotlight of claim 15, wherein the filter elements are coated on both sides.

17. The spotlight of claim 12, wherein the filters filter light of different wavelengths.

18. The spotlight of claim 10, wherein the chambers are radially offset in the rotatable portion from the rotational axis of the rotatable portion.

19. The spotlight of claim 7, wherein the rotational axis of one of the filter housing and the rotatable portion is parallel to and laterally disposed from the longitudinal axis of the spotlight.

20. The spotlight of claim 6, wherein the aperture is located in a housing separate from the filter housing.

21. The spotlight of claim 6, wherein the filter housing is formed integrally with the aperture.

22. The spotlight of claim 21, wherein the aperture is located in a recess portion of the filter housing and portion of the first lens, when positioned closely adjacent to the aperture, nests in the recess portion.

23. The spotlight of claim 22, wherein the recess portion is correspondingly shaped to the shape of the portion of said first lens.

24. The spotlight of claim 21, wherein the aperture is radially located in the filter housing to be aligned with one chamber.

25. The spotlight of claim 24, wherein the aperture is located on the opposite side of the filter housing to said at least one chamber.

26. The spotlight of claim 21, wherein the filter housing has a plurality of chambers and a plurality of apertures.

27. The spotlight of claim 26, wherein the plurality of apertures have differing diameters associated with different chambers of said plurality of chambers.

28. The spotlight of claim 1, wherein a second lens is provided which is moveable relative to the first lens so as to collimate the output light beam at different distances.

29. The spotlight of claim 28, wherein the first lens and said second lens are coated on a lens mounting for simultaneous movement.

30. The spotlight of claim 29, wherein the first lens and said second lens move at different linear rates to maintain an even beam profile.

31. (canceled)
